(19) United States
(12) Patent Application Publication
(10) Pub. No.: US 2010/0151359 A1
(43) Pub. Date: Jun. 17, 2010

(54) SEPARATOR FOR FUEL CELL AND METHOD OF FORMING COLLECTOR OF THE SEPARATOR

(75) Inventors: Hideto Tanaka, Okazaki-shi (JP); Kazunari Moteki, Okazaki-shi (JP)

Correspondence Address: ROSSI, KIMMS & McDOWELL LLP., 20609 Gordon Park Square, Suite 150, Ashburn, VA, 20147, US

(73) Assignees: TOYOTA SHATAI KABUSHIKI KAISHA, Kariya-shi, Aichi (JP); TOYOTA JIDOSHA KABUSHIKI KAISHA, Toyota-shi, Aichi (JP)

(21) Appl. No.: 12/519,118

(22) PCT Filed: Aug. 25, 2008
(86) PCT No.: PCT/JP2008/065615

§ 371 Date: Jul. 28, 2009

(30) Foreign Application Priority Data
Sep. 7, 2007 (JP) 2007-232232

(51) Int. Cl. H01M 8/02

(52) U.S. Cl. 429/514; 29/623.1

(57) ABSTRACT

A separator 10 includes a separator body 11 and a collector 12. The separator body 11 prevents mixed flow of fuel gas and oxidizer gas. The collector 12 is formed from a metal lath MR in which the angle between the direction of formation of strand portions (through-hole formation portions) for forming through holes in a meshy, step-like arrangement and the direction of formation of bond portions (connection portions) for connecting the strand portions to one another is about 60 degrees. By virtue of this, the thickness of the collector 12 can be increased through reduction in pitch P. Thus, a good gas supply performance is ensured through reduction in pressure loss of introduced gas, and water generated in an MEA 30 can be well drained by capillary action which arises in the through holes.

### TECHNICAL FIELD

The present invention relates to a separator for use in a fuel cell, particularly, a polymer electrolyte fuel cell, and to a method of forming a collector of the separator.

### BACKGROUND ART

Generally, a polymer electrolyte fuel cell includes an electrode structure which, in turn, includes an anode electrode layer formed on one side of an electrolyte membrane and a cathode electrode layer formed on the other side of the electrolyte membrane. In the polymer electrolyte fuel cell, fuel gas (e.g., hydrogen gas) and oxidizer gas (e.g., air) are externally supplied to the anode electrode layer and the cathode electrode layer, respectively. The supply of fuel gas and oxidizer gas induces electrode reactions in the electrode structure, thereby generating electricity. Thus, in order to improve the electricity generation efficiency of the polymer electrolyte fuel cell, it is important to efficiently supply the electrode structure the fuel gas and oxidizer gas required for electrode reactions.

Meanwhile, the polymer electrolyte fuel cell has a separator for supplying the anode electrode layer and the cathode electrode layer with the externally supplied fuel gas and oxidizer gas, respectively, in a mutually separated condition. Conventionally, the electricity generation efficiency of the polymer electrolyte fuel cell has been improved through improvement of efficiency in supply of fuel gas and oxidizer gas via the separator.

For example, Japanese Patent Application Laid-Open (kokai) No. 2007-87768 discloses a separator for a fuel cell. The separator includes a separator body which prevents mixed flow of fuel gas and oxidizer gas through separation of the fuel gas and the oxidizer gas from each other, and a collector which is formed from a lath metal (metal lath) having a large number of through holes formed in a meshy, step-like arrangement, forms a gas passageway for supplying the fuel gas or the oxidizer gas to the corresponding electrode layer, and collects generated electricity. In the fuel cell which employs the thus-configured separator, the fuel gas or the oxidizer gas separated by the separator body passes through the meshy through holes formed in the collector, thereby being sufficiently diffused. Therefore, the electricity generation efficiency of the polymer electrolyte fuel cell can be improved.

### DISCLOSURE OF THE INVENTION

The collector disclosed in Japanese Patent Application Laid-Open (kokai) No. 2007-87768 is formed from a metal lath manufactured by a general manufacturing method. Thus, usually, the thickness of the collector is small. As a result, resistance associated with flow of fuel gas or oxidizer gas to the corresponding electrode layer; i.e., pressure loss, may increase. Therefore, sufficient supply of fuel gas and oxidizer gas to the respective electrode layers may fail, leaving room for improvement. In this connection, a conceivable practice to increase the thickness of the collector; i.e., the thickness of metal lath, is, for example, to increase working length in shearing a material (e.g., metal sheet) in a staggered arrangement. However, since deformation resistance of the material is low, the increase of working length encounters difficulty in the manufacture of a metal lath having an appropriate thickness. Use of a metal lath having an inappropriate thickness may result in, for example, nonuniformity in shape of formed through holes and an increase in pressure loss.

Also, in the polymer electrolyte fuel cell, as electrode reactions using the fuel gas and oxidizer gas proceed in the electrode structure, water is generated in the anode electrode layer or the cathode electrode layer according to the ion exchange characteristic of the electrolyte membrane. The thus-generated water, for example, covers the surface of the anode electrode layer or the surface of the cathode electrode layer or adheres to the through holes formed in the collector, potentially impairing good supply of fuel gas or oxidizer gas. Thus, as the electrode reactions proceed, the possibility of a drop in electricity generation efficiency of the fuel cell increases. Also, in the case where the polymer electrolyte fuel cell is installed in an environment susceptible to low temperatures, the generated water remaining therein may be frozen, causing a failure in sufficient supply of fuel gas or oxidizer gas. As a result, the low-temperature start-up performance of the fuel cell may deteriorate. Therefore, water generated through electrode reactions must be efficiently drained outward.

The present invention has been achieved for solving the above-mentioned problems, and an object of the invention is to provide a separator for a fuel cell which exhibits both good performance of supply of fuel gas and oxidizer gas and good performance of drainage of water generated through electrode reactions.

To achieve the above object, according to a feature of the present invention, a separator for a fuel cell for supplying externally introduced fuel gas and oxidizer gas to respective electrode layers of an electrode structure of the fuel cell comprises a flat-sheet-like separator body preventing mixed flow of the fuel gas and the oxidizer gas through separation of the fuel gas and the oxidizer gas from each other, and a collector disposed between the electrode structure and the separator body, diffusing the fuel gas or the oxidizer gas separated by the separator body, supplying the diffused fuel gas or oxidizer gas to the corresponding electrode layer, and collecting electricity generated through electrode reactions in the electrode structure, an angle between a direction of formation of through-hole formation portions for forming through holes in a meshy, step-like arrangement and a direction of formation of connection portions for connecting the through-hole formation portions to one another being less than 90 degrees.

In this case, the angle between the direction of formation of through-hole formation portions and the direction of formation of connection portions in the collector may be, for example, about 60 degrees or greater. Also, the collector may be formed from a metal lath having a large number of small-diameter through holes which are formed in a meshy, step-like arrangement by means of strand portions corresponding to the through-hole formation portions and bond portions corresponding to the connection portions.

A method of forming a collector of a separator for a fuel cell may use a forming apparatus having a stationary die whose end portion for placing a sheet material thereon has a wedge-shaped section having an angle of less than 90 degrees, and a shearing die which is disposed in a direction of feed of the sheet material with respect to the stationary die and moves in a direction of thickness of the sheet material and in a direction of width of the sheet material, whose end portion coming in contact with the sheet material has a wedge-shaped section having an angle of less than 90 degrees so as to be compatible with the wedge-shaped section of the end portion of the stationary die, and which shears the sheet material so as to form through holes in the sheet material. The method may comprise a first step of feeding the sheet material by a predetermined working length, moving the shearing die in one direction with respect to the direction of width of the sheet material, and moving the shearing die in the direction of thickness of the sheet material so as to form the through holes, and a second step of, subsequent to the first step, feeding the sheet material by the predetermined working length, moving the shearing die in the other direction with respect to the direction of width of the sheet material, and moving the shearing die in the direction of thickness of the sheet material so as to form the through holes.

In this forming method, for example, the first step and the second step may be sequentially repeated. Also, the shearing die may have a plurality of shearing edges formed at predetermined intervals. In this case, each of the shearing edges may have, for example, a trapezoid or triangular shape as viewed on a section taken perpendicular to the direction of feed of the sheet material.

According to the above-mentioned configurations, the collector which partially constitutes the separator for a fuel cell can be formed from, for example, a metal lath and thus can have a large number of through holes having a small diameter and formed in a meshy, step-like arrangement. Thus, the collector causes the fuel gas or the oxidizer gas separated by the separator body to pass through a large number of the through holes formed therein, whereby the gas can be supplied to the corresponding electrode layer in a well diffused condition. Also, in the collector, the angle between the direction of formation of the through-hole formation portions (strand portions) and the direction of formation of the connection portions (bond portions) can be less than 90 degrees; more specifically, about 60 degrees to less than 90 degrees. Thus, when the collector is disposed between the electrode structure and the separator body, the plane of opening of each of the through holes can have a large angle with respect to the electrode structure (more specifically, the electrode layer) or the separator body; i.e., the through holes are in a steep posture.

Thus, even in the case of formation of through holes having the same diameter as that of conventional through holes, the thickness of the collector can be increased to an extent corresponding to the steepness. In other words, by means of forming through holes under working conditions sufficiently good as to be free from occurrence of the aforementioned defective working, the thickness of the collector can be increased. By virtue of an increase in thickness of the collector, pressure loss associated with flow of gas can be lowered, thereby ensuring sufficient gas supply performance with respect to supply of fuel gas and oxidizer gas required for electrode reactions in the electrode structure. Therefore, the electricity generation efficiency of the fuel cell can be greatly improved.

By means of setting the angle between the direction of formation of the through-hole formation portions and the direction of formation of the connection portions to less than 90 degrees (more specifically, about 60 degrees), the distance between the connection portions in the collector can be reduced. In other words, the through holes can be formed in proximity to one another. In a state in which the through holes are in proximity to one another, when water generated through electrode reactions reaches the vicinity of the collector, the capillary action which arises in the through holes renders the generated water more fluid. Also, in a state in which a fuel gas or oxidizer gas flows; i.e., in a state in which the fuel cell is activated, in addition to the capillary action, pressure for flow of gas acts on the generated water. Thus, the generated water, together with a portion of unreacted gas, can be efficiently drained to the exterior of the fuel cell. Accordingly, even in a state in which water is generated along with progress of electrode reactions, the generated water can be well drained. Therefore, good gas supply performance can be maintained, whereby a drop in electricity generation efficiency of the fuel cell can be prevented.

Furthermore, since the distance between the connection portions in the collector can be reduced, contacts between the electrode structure (more specifically, the electrode layer) or the separator body and the connection portions of the collector can be rendered dense. Thus, the collector can efficiently collect and output electricity generated through electrode reactions. Also, particularly, the dense contacts between the electrode structure and the connection portions of the collector can greatly reduce deformation of the electrode structure, whose substrate is a thin polymer membrane. Thus, a mechanical load which stems from the deformation and is imposed on the electrode structure can be greatly reduced, thereby preventing deterioration of the electrode structure which would otherwise result from the mechanical load.

### BRIEF DESCRIPTION OF THE DRAWINGS

FIG. 1 is a schematic view relating to an embodiment of the present invention and partially showing a fuel cell stack which employs separators for a fuel cell of the present invention;

FIG. 2 is a schematic, perspective view showing a separator body of the separator of FIG. 1;

FIGS. 3(a) and 3(b) are schematic views for explaining a collector (metal lath) of FIG. 1;

FIGS. 4(a) and 4(b) are schematic views for explaining the configuration of a metal-lath-forming apparatus for manufacturing the metal lath;

FIGS. 5(a) and 5(b) are schematic views for explaining the configuration of a conventional metal-lath-forming apparatus for manufacturing the metal lath;

FIGS. 6(a) and 6(b) are schematic views for explaining, as a comparative example, a metal lath manufactured by the metal-lath-forming apparatus of FIG. 5;

FIG. 7 is a view for explaining the difference in pitch between the metal lath shown in FIG. 3 and the metal lath shown in FIG. 6;

FIG. 8 is a schematic, perspective view for explaining a state of assembly of frames and an MEA shown in FIG. 1; and

FIG. 9 is a pair of schematic views showing modified through holes of the collector (metal lath).

### BEST MODE FOR CARRYING OUT THE INVENTION

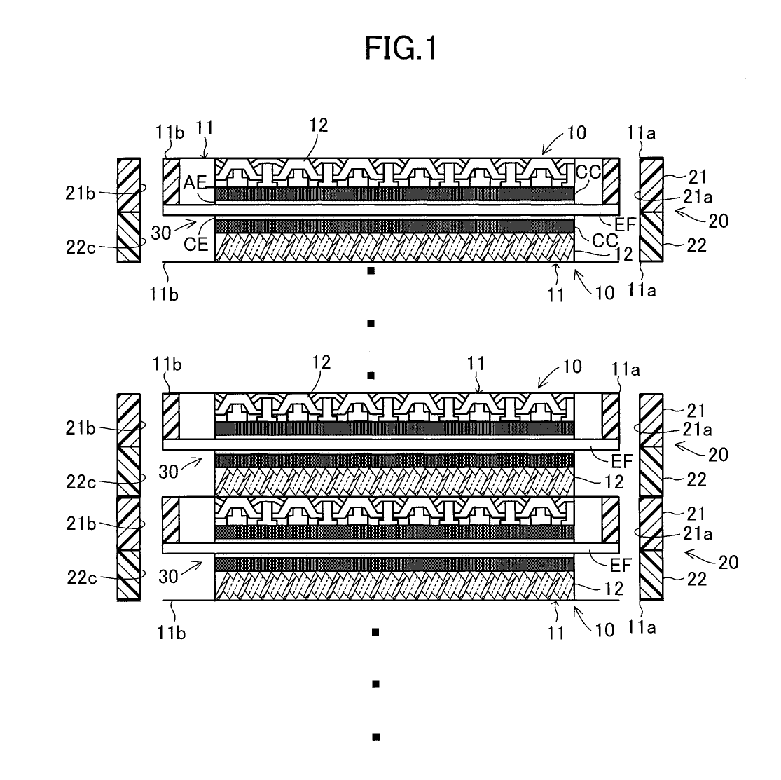

An embodiment of the present invention will next be described in detail with reference to the drawings. FIG. 1 is a sectional view schematically showing a portion of a polymer electrolyte fuel cell stack which employs separators 10 for a fuel cell (hereinafter, referred to merely as the separators 10) according to the present embodiment. The fuel cell stack is a stack of cells. A single cell includes two separators 10, two frames 20, and an MEA 30 (Membrane-Electrode Assembly 30). The frames 20 and the MEA 30 are disposed in layers between the separators 10.

When, for example, fuel gas such as hydrogen gas, and oxidizer gas such as air are introduced to the cells from the exterior of the fuel cell stack, electrode reactions occur in the MEAs 30, thereby generating electricity. Hereinafter, fuel gas and oxidizer gas may be collectively referred to merely as gas.

As shown in FIG. 1, each of the separators 10 includes a separator body 11 for preventing a mixed flow of gas introduced into the fuel cell stack, and a collector 12 for uniformly diffusing externally supplied fuel gas or oxidizer gas to the MEA 30 and for collecting electricity generated through electrode reactions.

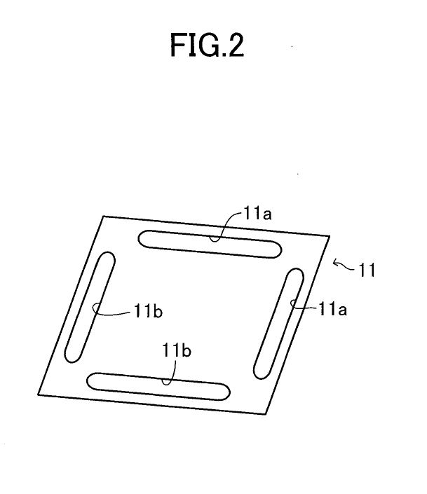

The separator body 11 is formed from a metal sheet (e.g., a stainless steel sheet having a thickness of about 0.1 mm). Another material which can be used to form the separator body 11 is, for example, a steel sheet which has undergone anticorrosive treatment such as gold plating. In place of a metal sheet, an electrically conductive nonmetal material (e.g., carbon) may also be used to form the separator body 11. As shown in FIG. 2, the separator body 11 is formed into a substantially square, flat-sheet-like shape. Two gas inlets 11a and two gas outlets 11b are formed in a peripheral region of the separator body 11 in such a manner that the gas inlets 11a face the corresponding gas outlets 11b. A pair consisting of the gas inlet 11a and the gas outlet 11b is oriented substantially orthogonal to the other pair consisting of the gas inlet 11a and the gas outlet 11b.

Each of the gas inlets 11a assumes the form of an elongated through hole and allows fuel gas or oxidizer gas supplied from the exterior of the fuel cell stack to be introduced therethrough into the corresponding cell and to flow therethrough so as to be supplied to other stacked cells. Each of the gas outlets 11b also assumes the form of an elongated through hole and allows discharge therethrough, to the exterior of the fuel cell stack, of gas which has been introduced into the corresponding cell but remains unreacted in the MEA 30, as well as flow therethrough of unreacted gas from other stacked cells.

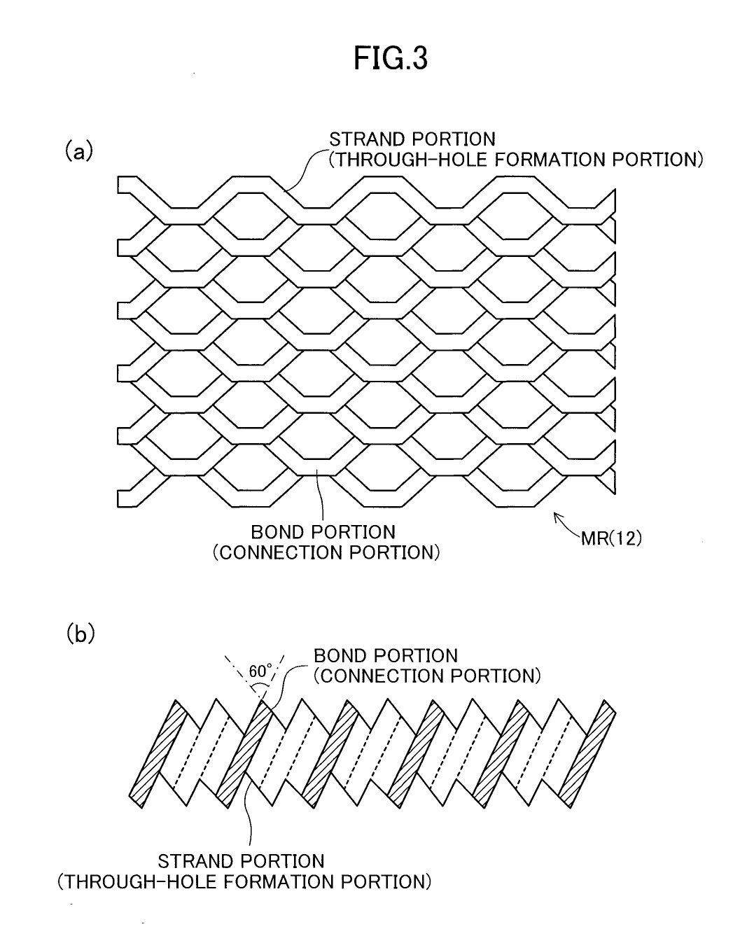

As shown in FIG. 3(a), the collector 12 is formed from a metal sheet having a large number of small-diameter through holes formed in a meshy, step-like arrangement (hereinafter, this metal sheet is called a metal lath MR). This metal lath MR is formed from a sheet material (e.g., stainless steel sheet) having a thickness of about 0.1 mm. The through holes formed in large quantity have a hole diameter of about 0.1 mm to 1 mm. As shown in FIG. 3(b), which is a side view as viewed from the left-right direction in FIG. 3(a), in the metal lath MR, those portions which form the through holes (hereinafter, these portions are called strand portions) are sequentially connected in an overlapping manner (hereinafter, these connection portions are called bond portions). Herein, the strand portions of the metal lath MR correspond to through-hole formation portions of the collector 12, and the bond portions of the metal lath MR correspond to connection portions of the collector 12. Next will be described lath machining for forming the metal lath MR.

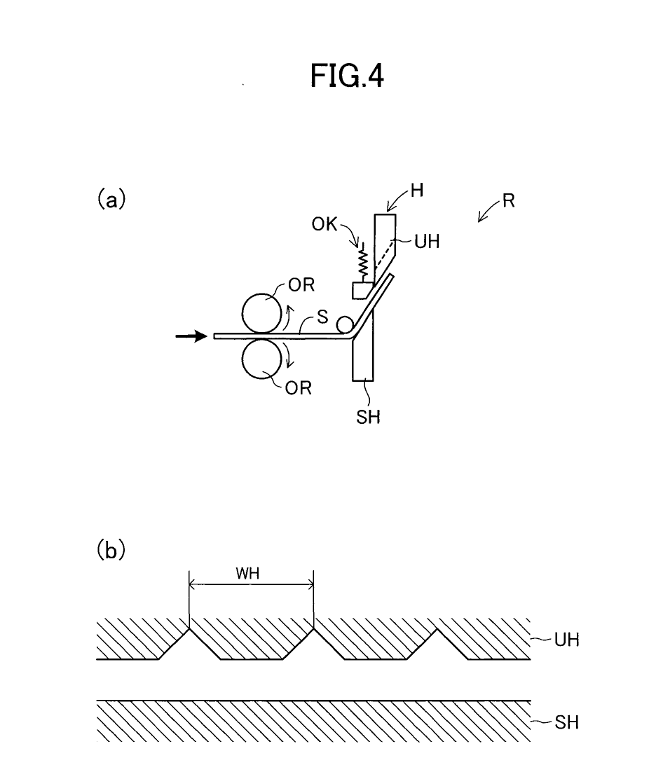

The metal lath MR is formed by use of a metal-lath-forming apparatus R, which is schematically shown in FIG. 4(a), in such a manner that a large number of through holes are formed in a stainless steel sheet S in a meshy, step-like arrangement. The metal-lath-forming apparatus R includes feed rollers OR for feeding the stainless steel sheet S; a press mechanism OK for appropriately fixing the stainless steel sheet S during working; and a blade stamp H for sequentially shearing the stainless steel sheet S so as to form through holes in a meshy arrangement. The stainless steel sheet S may assume the form of a precut sheet having a predetermined length or the form of a coil.

The blade stamp H consists of a lower blade SH which serves as a stationary die and is fixed to an unillustrated base and on which the stainless steel sheet S is placed, and an upper blade UH which serves as a shearing die and can move in the direction of thickness of the stainless steel sheet S (in the vertical direction on the paper on which FIG. 4(a) appears) and in the direction of width of the stainless steel sheet S (in the direction perpendicular to the paper on which FIG. 4(a) appears). As shown in FIG. 4(a), the lower blade SH is formed such that its end portion coming in contact with the stainless steel sheet S has a wedge-shaped section having an angle of, for example, about 60 degrees. As shown in FIG. 4(b), the edge of the lower blade SH coming in contact with the stainless steel sheet S is formed straight. The slope of the lower blade SH and the press mechanism OK hold the stainless steel sheet S therebetween, thereby fixing the stainless steel sheet S.

As shown in FIG. 4(a), the upper blade UH is formed such that its end portion coming in contact with the stainless steel sheet S has a wedge-shaped section having an angle of, for example, about 60 degrees so as to be compatible with the wedge-shaped section of the end portion of the lower blade SH. As shown in FIG. 4(b), in order to form cuts in the stainless steel sheet S by shearing work and to form through holes by stretching work, the cutting edge of the upper blade UH has a shape resembling a plurality of trapezoids arranged at predetermined intervals. The upper blade UH can be moved in the direction of thickness of the stainless steel sheet S and in the direction of width of the stainless steel sheet S by means of an unillustrated AC servomechanism.

In the thus-configured metal-lath-forming apparatus R, first, the feed rollers OR feed the stainless steel sheet S to the blade stamp H by a predetermined working length. The press mechanism OK and the slope of the lower blade SH fixedly hold the stainless steel sheet S therebetween. When the feed rollers OR feed the stainless steel sheet S to the blade stamp H, the upper blade UH of the blade stamp H lowers toward the lower blade SH; i.e., in the direction of thickness of the stainless steel sheet S, and shears the stainless steel sheet S by means of the substantially trapezoidal cutting edges and in cooperation with the lower blade SH, thereby forming cuts in the stainless steel sheet S. Subsequently, the upper blade UH lowers further to the bottom position of its stroke, thereby bending and stretching portions of the stainless steel sheet S which are in contact with the cutting edges of the upper blade UH, and thus forming strand portions. Then, the upper blade UH returns from the bottom position to the upper origin position of its stroke. In this manner, the strand portions to which the shape of the upper blade UH is transferred are formed on the stainless steel sheet S.

Subsequently, the feed rollers OR again feed the stainless steel sheet S to the blade stamp H by the predetermined working length. At this time, the upper blade UH moves (i.e., is offset) in the horizontal direction by half a working pitch; more specifically, by a cutting-edge length WH of the upper blade UH. Then, the upper blade UH lowers again as mentioned above. This performs the above-mentioned cutting work and bending-stretching work on the stainless steel sheet S at positions which are offset leftward or rightward by half the working pitch from the strand portions formed by the previous lowering stroke of the upper blade UH, thereby forming new strand portions to which the shape of the upper blade UH is transferred. Thus, as shown in FIG. 3(a), substantially hexagonal through holes are formed in the stainless steel sheet S by means of the strand portions.

Repeating the above-mentioned operations forms continuously the metal lath MR in which a large number of through holes are formed in a staggered meshy arrangement. Since the upper blade UH has a plurality of substantially trapezoidal cutting edges, lowering the upper blade UH leaves cut-free portions on the stainless steel sheet S. The cut-free portions of the stainless steel sheet S become bond portions of the metal lath MR, whereby the strand portions are sequentially connected in an overlapping manner. The metal lath MR is cut so as to have predetermined dimensions, thereby forming the collector 12.

As mentioned previously, the end portion of the lower blade SH and the end portion of the upper blade UH which come into contact with the stainless steel sheet S have a wedge-shaped section having an angle of about 60 degrees. The metal lath MR is formed by means of the lower blade SH and the upper blade UH each having the wedge-like shape. Thus, in the metal lath MR formed by the metal-lath-forming apparatus R, as shown in FIG. 3(b), the angle between the direction of formation of the simultaneously formed bond portions (i.e., the bond portions in the same row) and the direction of formation of the strand portions connected to the bond portions and forming the through holes becomes less than 90 degrees; more specifically, about 60 degrees.

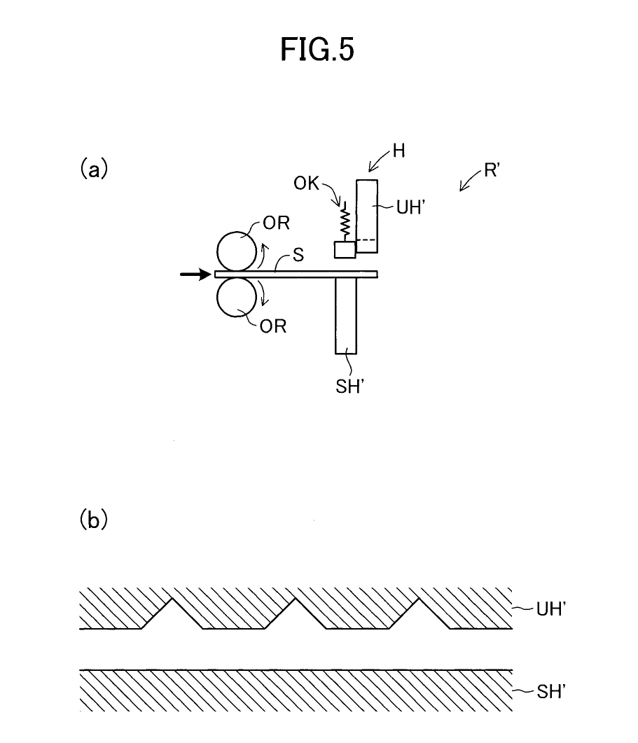

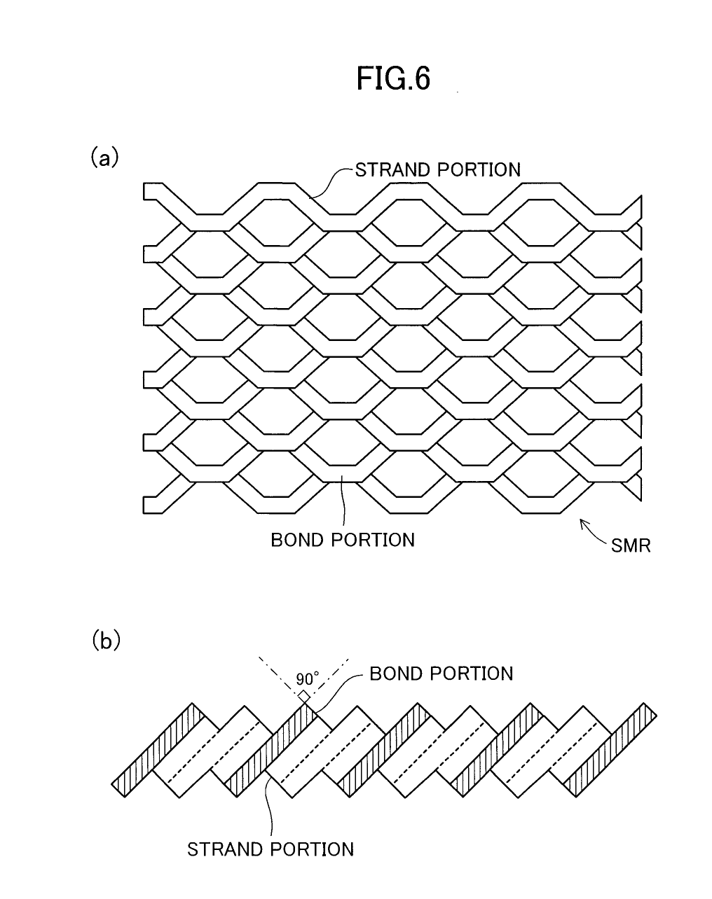

As schematically shown in FIGS. 5(a) and 5(b), a general manufacturing method used to form a conventional metal lath SMR uses a metal-lath-forming apparatus R′ employing a lower blade SH′ and an upper blade UH′ whose end portions coming into contact with the stainless steel sheet S have a section having a flat end, rather than a wedge-shaped section. Similar to the above-mentioned manufacture of the metal lath MR, the metal-lath-forming apparatus R′ using the lower blade SH′ and the upper blade UH′ forms a large number of through holes in the stainless steel sheet S in a staggered meshy arrangement, thereby yielding the metal lath SMR. In the conventional metal-lath-forming apparatus R′ using the lower blade SH′ and the upper blade UH′, the lower blade SH′ and the press mechanism OK hold the stainless steel sheet S therebetween in such a manner that the stainless steel sheet S lies in the horizontal direction, and the upper blade UH′ moves up and down in the direction of thickness of the stainless steel sheet S; i.e., in the vertical direction. Accordingly, as shown in FIG. 6, in the manufactured metal lath SMR, the angle between the direction of formation of bond portions and the direction of formation of strand portions becomes about 90 degrees.

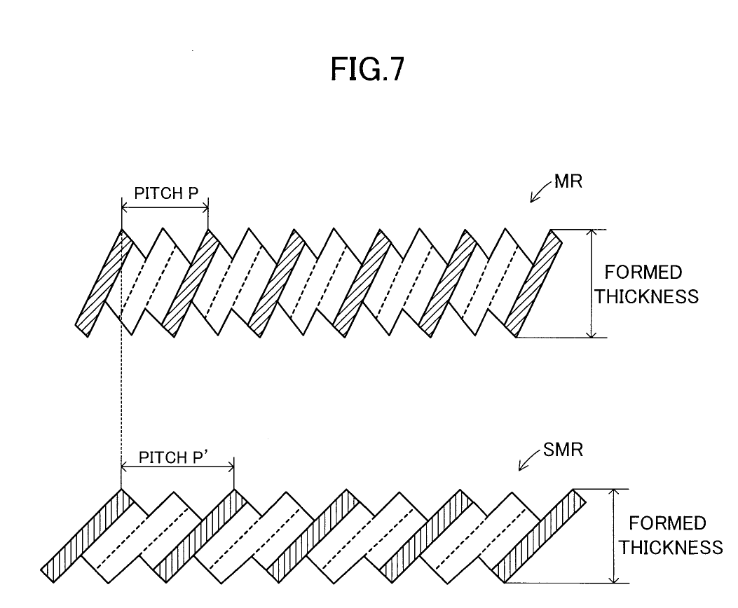

By contrast, in manufacture of the metal lath MR, while the lower blade SH and the press mechanism OK hold the stainless steel sheet S therebetween in such a manner that the stainless steel sheet S is inclined upward at about 60 degrees with respect to the horizontal direction, the upper blade UH moves up and down in the vertical direction. Thus, as shown in FIG. 3(b), the angle between the direction of formation of bond portions and the direction of formation of strand portions becomes about 60 degrees. That is, when the metal lath MR and the metal lath SMR are placed on a horizontal plane, as shown in FIG. 7, the angle between the horizontal plane and a plane which contains the strand portions of the metal lath MR is greater than that between the horizontal plane and a plane which contains the strand portions of the metal lath SMR. In other words, the through holes which are formed in the metal lath MR in a meshy arrangement are in a so-called steeper posture as compared with the through holes which are formed in the conventional metal lath SMR in a meshy arrangement.

Since the metal lath MR can have a large angle between the formed strand portions and the horizontal plane, the metal lath MR can have a sufficient formed thickness. As will be described later, in order to ensure good flow of fuel gas or oxidizer gas, a gap between the separator body 11 and the MEA 30 must be increased. In this case, since the collector 12 formed from the metal lath MR can have a large thickness, the gap can be increased accordingly.

By contrast, in manufacture of the conventional metal lath SMR, in order to increase the formed thickness of the metal lath SMR, the working length of the stainless steel sheet S to be fed by the feed rollers OR must be increased. However, if, in order to impart a large formed thickness to the metal lath SMR, the working length of the stainless steel sheet S to be fed by the feed rollers OR is increased, difficulty is encountered in forming strand portions, since deformation resistance of the thin stainless steel sheet S is low.

Also, as shown in FIG. 7, in the metal lath MR, the distance between the bond portions; i.e., a pitch P, can be reduced. Thus, when the MEA 30 and the collector 12 formed from the metal lath MR are assembled together in contact with each other, contact intervals between the MEA 30 and the connection portions of the collector 12 can be shortened (rendered dense). Accordingly, the deformation (waviness) of the MEA 30 in an assembled condition can be greatly reduced. Therefore, a mechanical load imposed on the MEA 30 can be greatly reduced; thus, sufficient durability of the MEA 30 can be ensured.

By contrast, as shown in FIG. 7, in the conventional metal lath SMR, the distance between the bond portions; i.e., a pitch P′, is increased. Particularly, in the case where the working length is increased in order to increase the formed thickness of the metal lath SMR, the pitch P′ is increased further. Thus, for example, when the collector 12 is formed from the metal lath SMR, contact intervals between the MEA 30 and the connection portions of the collector 12 are lengthened. As a result, the MEA 30 in an assembled condition is deformed (waved), and an associated imposition of mechanical load on the MEA 30 may impair durability.

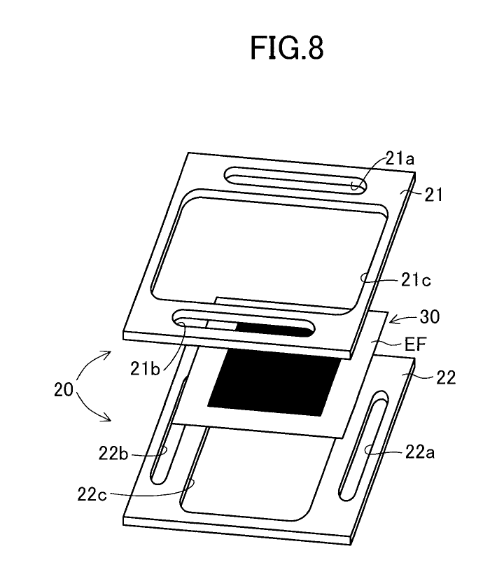

As shown in FIG. 8, a frame 20 consists of two resin sheet bodies 21 and 22 of the same structure. One side of each of the resin sheet bodies 21 and 22 is fixedly attached to a corresponding one of two separators 10 (more specifically, two separator bodies 11). The resin sheet bodies 21 and 22 have outside dimensions substantially identical with those of the separator body 11 and a thickness slightly smaller than the formed height of the collector 12. The resin sheet bodies 21 and 22 are laminated together while being disposed in such a manner as to differ in an angular, planar orientation by about 90 degrees. Various resin materials can be employed to form the resin sheet bodies 21 and 22. Preferably, a glass epoxy resin is employed.

Through holes 21a and 21b which correspond to and are shaped substantially similar to the gas inlet 11a and the gas outlet 11b, respectively, are formed in a peripheral region of the resin sheet body 21, and through holes 22a and 22b which correspond to and are shaped substantially similar to the gas inlet 11a and the gas outlet 11b, respectively, are formed in a peripheral region of the resin sheet body 22. In a state in which a single cell is formed, the through holes 21a, 21b, 22a, and 22b positionally coincide with the corresponding gas inlets 11a and gas outlets 11b. Accommodation holes 21c and 22c for accommodating the respective collectors 12 joined to the separator bodies 11 are formed in substantially central regions of the resin sheet bodies 21 and 22, respectively. In the form of a single cell, the accommodation hole 21c of the resin sheet body 21 communicates with a pair consisting of the gas inlet 11a and the gas outlet 11b of the separator body 11 fixed to the resin sheet body 21, and communicates with the through holes 22a and 22b of the resin sheet body 22, whereas the accommodation hole 22c of the resin sheet body 22 communicates with the other pair consisting of the gas inlet 11a and the gas outlet 11b of the separator body 11 fixed to the resin sheet body 22, and communicates with the through holes 21a and 21b of the resin sheet body 21.

As a result of formation of the accommodation holes 21c and 22c, the lower surface (upper surface) of the attached separator body 11, the inner peripheral surface of the accommodation hole 21c (22c), and the upper surface (lower surface) of the MEA 30 define a space (hereinafter, called a gas flow space). For example, fuel gas can be introduced into the corresponding gas flow space through one gas inlet 11a, whereas oxidizer gas can be introduced into the corresponding gas flow space through the other gas inlet 11a and through the through hole 21a. Also, unreacted gas which has passed through the gas flow space can be discharged outward through one gas outlet 11b or through the other gas outlet 11b and the through hole 21b.

As shown in FIGS. 1 and 8, the MEA 30, which serves as an electrode structure, is configured such that predetermined catalyst layers are formed on respective sides of an electrolyte membrane EF; more specifically, an anode electrode layer AE is formed on the side toward the gas flow space into which fuel gas is introduced, and a cathode electrode layer CE is formed on the side toward the gas flow space into which oxidizer gas is introduced. Since actions (electrode reactions) of the electrolyte membrane EF, the anode electrode layer AE, and the cathode electrode layer CE are widely known and not directly related to the present invention, detailed description thereof is omitted in the following description.

The electrolyte membrane EF is formed of an ion exchange membrane (e.g., NAFION (registered trademark of a product of Du Pont)) which is selectively permeable to cations (more specifically, hydrogen ions (H⁺), or an ion exchange membrane (e.g., NEOCEPTOR (registered trademark of a product of Tokuyama)) which is selectively permeable to anions (more specifically, hydroxide ions (OH⁻). The size of the electrolyte membrane EF is determined so as to be greater than a substantially square opening which is formed when the resin sheet bodies 21 and 22 of the frame 20 are superposed on each other, and so as not to cover the through holes 21a and 21b and the through holes 22a and 22b when the electrolyte membrane EF is sandwiched between the resin sheet bodies 21 and 22. Such formation of the electrolyte membrane EF prevents gas introduced into one gas flow space from leaking into the other gas flow space (so-called crossleak).

The anode electrode layer AE and the cathode electrode layer CE, which serve as the electrode layers in the present invention, contain carbon (carrier carbon) which carries noble-metal catalyst (e.g., platinum), or a hydrogen storage alloy, as a main component. The anode electrode layer AE and the cathode electrode layer CE are formed on the respective surfaces of the electrolyte membrane EF. The anode electrode layer AE and the cathode electrode layer CE are slightly smaller in size than the substantially square opening which is formed when the resin sheet bodies 21 and 22 of the frame 20 are superposed on each other.

An exposed surface of each of the anode electrode layer AE and the cathode electrode layer CE is covered with a carbon cloth CC formed from electrically conductive fiber. The carbon cloth CC is adapted to uniformly supply fuel gas or oxidizer gas supplied into the corresponding gas flow space to an associated electrode layer and to efficiently supply electricity generated through electrode reactions to the associated collector 12. Since the carbon cloth CC is fibrous, supplied gas flows through interfiber space to thereby be uniformly diffused. Since the carbon cloth CC is electrically conductive, the carbon cloth CC allows efficient flow of generated electricity to the associated collector 12. The carbon cloths CC may be eliminated as needed.

A single cell is formed by arranging in layers the separator body 11, the collector 12, the frame 20, and the MEA 30. Specifically, as shown in FIG. 7, the MEA 30 is disposed between the two vertically arranged frames 20 which are disposed in such a manner as to differ in an angular, planar orientation by about 90 degrees. The thus-arranged elements are joined together, for example, through application of adhesive such that the electrolyte membrane EF of the MEA 30 is sandwiched between the frames 20.

The collectors 12 are fitted into the resultant assembly of the frames 20 and the MEA 30; more specifically, the collectors 12 are accommodated in the respective accommodation holes 21c and 22c of the frames 20. At this time, the collectors 12 are accommodated in the respective accommodation holes 21c and 22c of the frames 20 in such a manner that the opening direction of the through holes of meshy arrangement of each of the collectors 12 (the metal laths MR) coincides with the direction of arrangement of the paired through holes 21a and 21b (through holes 22a and 22b) formed in the frame 20 in which the collector 12 is accommodated; i.e., the opening direction coincides with the flow direction of introduced gas.

In a state where the collectors 12 are accommodated in the respective accommodation holes 21c and 22c of the frame 20, the separator bodies 11 are fixedly attached to the frame 20, for example, through application of adhesive. Since the resin sheet bodies 21 and 22 have a thickness slightly smaller than the formed height of the collectors 12, attachment of the separator bodies 11 causes the collectors 12 to be slightly pressed against the MEA 30. Thus, a good state of contact is established between the collectors 12 and the MEA 30 (more specifically, carbon cloths CC). A plurality of the thus-formed cells are stacked in accordance with required output, thereby yielding a fuel cell stack.

In the thus-configured fuel cell stack, as shown in FIG. 1, among the stacked cells, the gas inlets 11a of the separator bodies 11 communicate with one another through the through holes 21a and 22a of the frames 20, and the gas outlets 11b of the separator bodies 11 communicate with one another through the through holes 21b and 22b of the frames 20. Thus, hereinafter, a communication passageway formed by the gas inlets 11a and the through holes 21a and 22a of the frames 20 in each unit cell is called a gas supply inner-manifold, and a communication passageway formed by the gas outlets 11b and the through holes 21b and 22b of the frames 20 in each unit cell is called a gas discharge inner-manifold.

When fuel gas or oxidizer gas is externally supplied through the gas supply inner-manifold, the supplied fuel gas or oxidizer gas is introduced into each of the gas flow spaces. The thus-introduced fuel gas or oxidizer gas uniformly diffuses and flows throughout the gas flow space by virtue of the collector 12.

Specifically, gas which is introduced into each of the gas flow spaces from the gas supply inner-manifold flows toward the gas discharge inner-manifold while contacting the collector 12 disposed in the gas flow space. As mentioned previously, the collector 12 is formed from the metal lath MR in which a large number of substantially hexagonal through holes are formed in a meshy, step-like arrangement. More specifically, a large number of through holes of the collector 12 are in a staggered arrangement in relation to a gas flow direction.

Thus, a flow of gas in the gas flow space becomes a turbulent flow as a result of the gas passing through the through holes formed in a staggered arrangement in the collector 12; i.e., in the metal lath MR. Thus, gas introduced from the gas supply inner-manifold diffuses uniformly in the gas flow space; in other words, a gas concentration gradient becomes uniform. By virtue of a uniform gas concentration gradient in the gas flow space and passage of gas through the carbon cloth CC, fuel gas and oxidizer gas are supplied uniformly to the anode electrode layer AE and the cathode electrode layer CE, respectively.

Furthermore, as mentioned previously, the collector 12 is formed from the metal lath MR whose formed thickness is increased. Thus, the collector 12 can ensure excellent gas diffusivity mentioned above and can reduce flow resistance; i.e., pressure loss, of gas flowing through the gas flow space. Additionally, resistance associated with flow of gas introduced into the gas flow space through a large number of uniformly formed small-diameter through holes can also be reduced. Thus, gas can smoothly flow through the gas flow space.

By virtue of uniform diffusion of gas and smooth flow of gas through the gas flow space, the anode electrode layer AE and the cathode electrode layer CE can efficiently perform electrode reactions with supplied fuel gas and oxidizer gas, respectively. As a result, the fuel cell can exhibit a greatly improved electrode reaction efficiency. Also, since supplied gas can be effectively utilized, unreacted gas reduces. Therefore, the fuel cell can efficiently generate electricity.

Meanwhile, electricity that is generated efficiently by virtue of improvement in electricity generation efficiency of the fuel cell is output to the exterior of the fuel cell via the collectors 12 and the separator bodies 11. In the collector 12, a large number of small-diameter through holes are formed, and the distance between the connection portions; i.e., the pitch P, is small. Thus, the surface area per unit volume; i.e., the area of contact with the MEA 30, is large. By virtue of the large area of contact with the MEA 30, resistance associated with collection of electricity generated in the MEA 30 (electricity collection resistance) can be greatly reduced. Therefore, generated electricity can be efficiently collected; i.e., electricity collection efficiency can be improved.

In the MEA 30, which partially constitutes the polymer electrolyte fuel cell, as well known, water is generated in the anode electrode layer AE or the cathode electrode layer CE as a result of electrode reactions using fuel gas and oxidizer gas. Specifically, for example, in the case where the electrolyte membrane EF of the MEA 30 is formed from an ion exchange membrane selectively permeable to cations, water is generated in the cathode electrode layer CE according to the following Reaction Formulas 1 and 2.

Anode electrode layer: H₂→2H⁺+2e⁻ Reaction Formula 1

Cathode electrode layer: 2H⁺+2e⁻+(½)O₂→H₂O Reaction Formula 2

Also, for example, in the case where the electrolyte membrane EF of the MEA 30 is formed from an ion exchange membrane selectively permeable to anions, water is generated in the anode electrode layer AE according to the following Reaction Formulas 3 and 4.

Anode electrode layer: H₂+2OH⁻→2H₂O+2e⁻ Reaction Formula 3

Cathode electrode layer: (½)O₂+H₂O+2e⁻→2OH⁻ Reaction Formula 4

When water is generated in large amount in the anode electrode layer AE or the cathode electrode layer CE according to the above formulas, supply of fuel gas or oxidizer gas may be hindered; i.e., a flooding state may arise. Upon occurrence of the flooding state, the generated water covers the surface of the anode electrode layer AE or the cathode electrode layer CE and also passes through the carbon cloth CC, thereby reaching the collector 12.

Meanwhile, the collector 12 is configured such that the angle between the direction of formation of connection portions and the direction of formation of through-hole formation portions for forming the through holes is less than 90 degrees; in other words, the pitch P is small, so that the through holes are in a steep posture. Thus, for example, as compared with the case of formation of the collector 12 from the metal lath SMR, the sequentially formed through holes are arranged closer to one another with respect to a gas flow direction. When the generated water reaches the vicinity of the small-diameter through holes arranged close to one another, by virtue of pressure of gas passing through the through holes and the capillary action, the generated water which has reached the collector 12 is well drained outward.

Specifically, in the collector 12 formed from the metal lath MR, the pitch P is small; thus, a larger number of the planes of openings of the formed through holes are in contact with the MEA 30 (more specifically, with the carbon cloth CC). Thus, the generated water which has reached the collector 12 fluidly moves toward the interiors of the through holes by the effect of capillary action induced by its surface tension. In addition to the fluid movement of the generated water, the pressure of gas flowing through the gas flow space acts on the generated water. Thus, the generated water which has reached the collector 12 is drained on the stream of a portion of unreacted gas to the exterior of the fuel cell stack.

As a result of the above-mentioned outward drainage of the generated water which has reached the collector 12, for example, excess water, which is the remainder of the generated water present in the vicinity of the anode electrode layer AE or the cathode electrode layer CE after consumption for moistening the electrolyte membrane EF, reaches the vicinity of the collector 12 continuously via the carbon cloth CC and is then drained. Such drainage of the generated water is continuously performed during operation of the fuel cell; in other words, so long as fuel gas and oxidizer gas are supplied.

Thus, during operation of the fuel cell, by virtue of capillary action in the collector 12 and flow of fuel gas or oxidizer gas, the generated water is not stagnated in the collector 12. Also, excess generated water is not stagnated in the anode electrode layer AE or the cathode electrode layer CE. Therefore, the occurrence of a flooding state can be well prevented. Since, during operation of the fuel cell, the generated water is continuously drained to the exterior of the fuel cell stack, there can be greatly reduced the amount of the generated water which, after stopping of operation of the fuel cell, remains in the individual cells; more specifically, in the anode electrode layers AE or the cathode electrode layers CE, and in the collectors 12. Thus, for example, even when the fuel cell is installed in an environment susceptible to low temperatures (0° C. or below), a drop in supply of gas, which could otherwise result from freezing of the generated water, can be prevented, so that the fuel cell can exhibit good low-temperature start-up performance.

As will be understood from the above description, according to the present embodiment, the collector 12 can be formed from the metal lath MR in which a large number of small-diameter through holes are formed in a meshy, step-like arrangement. Thus, fuel gas or oxidizer gas separated by the separator body 11 can be well diffused and supplied to the anode electrode layer AE or the cathode electrode layer CE. The metal lath MR is manufactured in such a manner that the angle between the direction of formation of strand portions and the direction of formation of bond portions becomes about 60 degrees. Thus, when the collector 12 is disposed between the MEA 30 and the separator body 11, the plane of opening of each of the through holes can have a large angle with respect to the MEA 30 or the separator body 11 (i.e., the through holes can be in a so-called steep posture).

Thus, for example, when the through holes of the metal lath MR are rendered identical in diameter with the through holes of the metal lath SMR, the thickness of the collector 12 can be increased. In other words, even when the metal lath MR is formed with the same working length and the same through-hole diameter as those of the conventionally manufactured metal lath SMR, the collector 12 formed from the metal lath MR can have an increased thickness. By virtue of an increase in thickness of the collector 12, pressure loss associated with flow of gas can be lowered, thereby ensuring sufficient gas supply performance with respect to supply of fuel gas and oxidizer gas required for electrode reactions in the MEA 30. Therefore, the electricity generation efficiency of the fuel cell can be greatly improved.

By means of forming the collector 12 from the metal lath MR, the distance between bond portions; i.e., the pitch P, in the collector 12 can be reduced. In other words, the through holes of the collector 12 can be arranged in proximity to one another. In a state in which the through holes are in proximity to one another, when water generated through electrode reactions reaches the vicinity of the collector 12, the capillary action which arises in the through holes renders the generated water more fluid. Also, in a state in which fuel gas or oxidizer gas flows, in addition to the capillary action, pressure for flow of gas acts on the generated water. Thus, the generated water, together with a portion of unreacted gas, can be efficiently drained to the exterior of the fuel cell. Accordingly, even in a state in which water is generated along with progress of electrode reactions, the generated water can be well drained. Therefore, good gas supply performance can be maintained through prevention of occurrence of flooding, whereby a drop in electricity generation efficiency of the fuel cell can be prevented.

Furthermore, since the pitch P in the collector 12 can be reduced, contacts between the MEA 30 (more specifically, the anode electrode layer AE or the cathode electrode layer CE, far more specifically, the carbon cloth CC) or the separator body 11 and the bond portions of the collector 12 can be rendered dense. Thus, the collector 12 can efficiently collect and output electricity generated through electrode reactions.

Also, particularly, the dense contacts between the MEA 30 and the collector 12 can greatly reduce deformation of the MEA 30, whose substrate is a thin electrolyte membrane EF. Thus, a mechanical load imposed on the MEA 30 can be greatly reduced, thereby preventing deterioration of the MEA 30 which would otherwise result from the imposition of mechanical load.

The present invention is not limited to the above-described embodiment, but may be embodied in various other forms without departing from the scope of the invention.

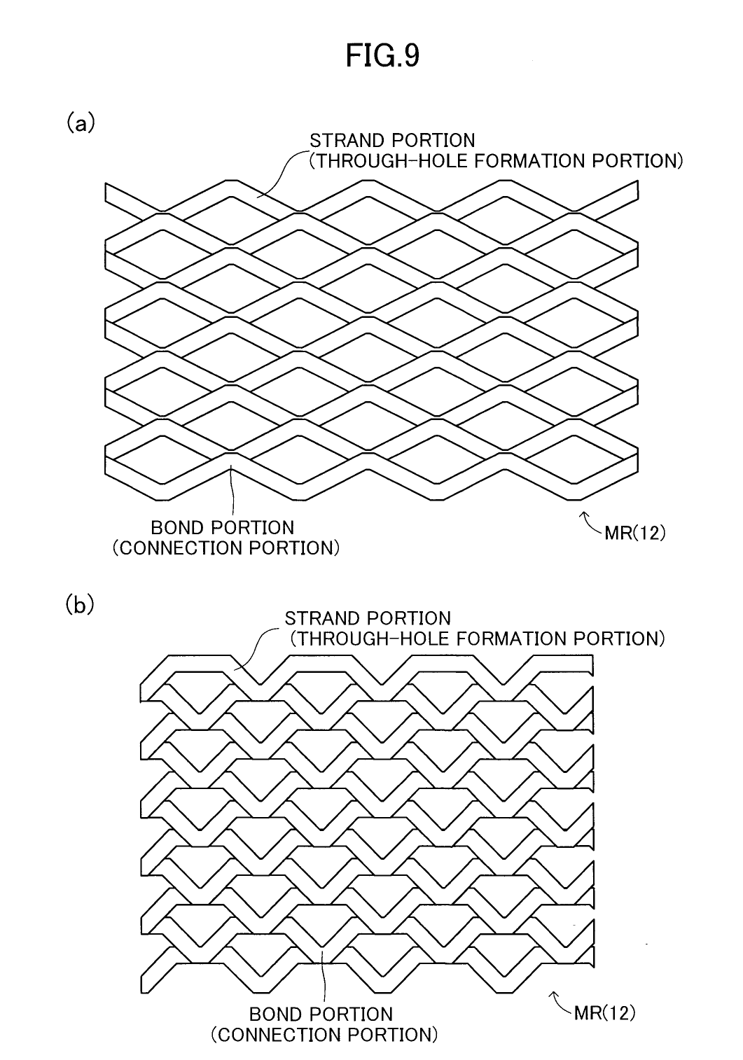

For example, in the above-described embodiment, the through holes formed in the collector 12 (metal lath MR) have a substantially hexagonal shape. However, no particular limitation is imposed on the shape of the through holes formed in the collector 12 (metal lath MR) so long as fuel gas or oxidizer gas can pass therethrough. For example, as shown in FIGS. 9(a) and 9(b), the through holes can have a polygonal opening shape, such as a quadrangular (diamond) opening shape or a pentagonal opening shape. In this case, particularly, in the case of formation of through holes having a quadrangular (diamond) opening shape, the upper blade UH which serves as a shearing die may have a plurality of substantially triangular cutting edges formed at predetermined intervals.

According to the above-described embodiment, in formation of a single cell, after the collector 12 is placed in each of the accommodation holes 21c and 22c of the frame 20, the separator body 11 is assembled to each of the resin sheet bodies 21 and 22. However, a single cell can also be formed as follows: after the separator bodies 11 and the collectors 12 are respectively joined together by a metal joining process, the collectors 12 are placed in the respective accommodation holes 21c and 22c of the frame 20, and the separator bodies 11 are assembled to the respective resin sheet bodies 21 and 22. In this case, the separator body 11 and the collector 12 may be joined together by a well-known process, such as brazing, welding, or diffusion bonding.

1. A separator for a fuel cell for supplying externally introduced fuel gas and oxidizer gas to respective electrode layers of an electrode structure of the fuel cell, characterized by comprising:
a flat-sheet-like separator body preventing mixed flow of the fuel gas and the oxidizer gas through separation of the fuel gas and the oxidizer gas from each other, and
a collector disposed between the electrode structure and the separator body, diffusing the fuel gas or the oxidizer gas separated by the separator body, supplying the diffused fuel gas or oxidizer gas to the corresponding electrode layer, and collecting electricity generated through electrode reactions in the electrode structure, an angle between a direction of formation of through-hole formation portions for forming through holes in a meshy, step-like arrangement and a direction of formation of connection portions for connecting the through-hole formation portions to one another being less than 90 degrees.

2. A separator for a fuel cell according to claim 1, wherein the angle between the direction of formation of through-hole formation portions and the direction of formation of connection portions in the collector is about 60 degrees or greater.

3. A separator for a fuel cell according to claim 1 or 2, wherein the collector is formed from a metal lath having a large number of small-diameter through holes which are formed in a meshy, step-like arrangement by means of strand portions corresponding to the through-hole formation portions and bond portions corresponding to the connection portions.

4. A method of forming a collector of a separator for a fuel cell according to claim 1, characterized by using:
a forming apparatus having a stationary die whose end portion for placing a sheet material thereon has a wedge-shaped section having an angle of less than 90 degrees, and a shearing die which is disposed in a direction of feed of the sheet material with respect to the stationary die and moves in a direction of thickness of the sheet material and in a direction of width of the sheet material, whose end portion coming in contact with the sheet material has a wedge-shaped section having an angle of less than 90 degrees so as to be compatible with the wedge-shaped section of the end portion of the stationary die, and which shears the sheet material so as to form through holes in the sheet material, and comprising:
a first step of feeding the sheet material by a predetermined working length, moving the shearing die in one direction with respect to the direction of width of the sheet material, and moving the shearing die in the direction of thickness of the sheet material so as to form the through holes, and
a second step of, subsequent to the first step, feeding the sheet material by the predetermined working length, moving the shearing die in the other direction with respect to the direction of width of the sheet material, and moving the shearing die in the direction of thickness of the sheet material so as to form the through holes.

5. A method of forming a collector of a separator for a fuel cell according to claim 4, wherein the first step and the second step are sequentially repeated.

6. A method of forming a collector of a separator for a fuel cell according to claim 4, wherein the shearing die has a plurality of shearing edges formed at predetermined intervals.

7. A method of forming a collector of a separator for a fuel cell according to claim 6, wherein each of the shearing edges has a trapezoid or triangular shape as viewed on a section taken perpendicular to the direction of feed of the sheet material.
